(19) United States
(12) Patent Application Publication
(10) Pub. No.: US 2021/0367357 A1
(43) Pub. Date: Nov. 25, 2021

(54) Millimeter-Wave Antenna Module and Electronic Device

(71) Applicant: GUANGDONG OPPO MOBILE TELECOMMUNICATIONS CORP., LTD., Dongguan (CN)

(72) Inventor: Yuhu Jia, Dongguan (CN)

(21) Appl. No.: 17/397,398

(22) Filed: Aug. 9, 2021

Related U.S. Application Data
(63) Continuation of application No. PCT/CN2020/078926, filed on Mar. 12, 2020.

(30) Foreign Application Priority Data
Mar. 30, 2019 (CN) 201910211412.2

(51) Int. Cl. H01Q 21/28; H01Q 21/00; H01Q 1/24

(52) U.S. Cl. CPC H01Q 21/28; H01Q 1/241; H01Q 21/0031

(57) ABSTRACT

Provided are a millimeter-wave antenna module and an electronic device. The electronic device comprises a rear housing, a main circuit board disposed apart from and faced to the rear housing, and the millimeter-wave antenna module. The millimeter-wave antenna module comprises: an antenna array, disposed on the rear housing and configured to receive or transmit millimeter-wave signals; a feeding module, disposed between the rear housing and the main circuit board, and arranged opposite to the antenna array, wherein the feeding module is connected to the main circuit board, and configured to perform coupled feeding to the antenna array; and a buffer layer, disposed between the antenna array and the feeding module, and having a dielectric constant greater than that of air and less than that of the rear housing.

### CROSS-REFERENCE TO RELATED APPLICATION(S)

This application is a continuation of the International Patent Application No. PCT/CN2020/078926, filed Mar. 12, 2020, which claims priority to Chinese Patent Application Serial No. 201910211412.2, the entire content of both of which are incorporated herein by reference.

### TECHNICAL FIELD

The present disclosure relates to a field of communication technologies, and more particularly to a millimeter-wave antenna module and an electronic device.

### BACKGROUND

The statements in this section merely provide background information related to the present disclosure and may not constitute prior art.

Millimeter-wave (Mm-wave) is an electromagnetic wave between a microwave and a light wave, usually has a frequency band of 30 to 300 GHz and a corresponding wavelength of 1 to 10 mm, and thus may provide a relative wide band. With the rapid growth of the amount of information, the amount of circulation transmitted will also increase, so that millimeter-wave frequency band transmission technology has been regarded as one communication technology with high transmission capabilities.

A millimeter-wave antenna array is traditionally disposed under a housing of an electronic device, which will affect a radiation efficiency of the antenna and reduce gain of millimeter-wave antenna module due to a relative high dielectric constant of the housing.

### SUMMARY

The present disclosure provides in embodiments a millimeter-wave antenna module and an electronic device.

In a first aspect of the present disclosure, the electronic device is provided. The electronic device includes a rear housing, a main circuit board disposed apart from and faced to the rear housing, and the millimeter-wave antenna module. The millimeter-wave antenna module includes an antenna array, disposed on the rear housing and configured to receive or transmit millimeter-wave signals; a feeding module, disposed between the rear housing and the main circuit board, and arranged opposite to the antenna array, in which the feeding module is connected to the main circuit board, and configured to perform coupled feeding to the antenna array; and a buffer layer, disposed between the antenna array and the feeding module, and having a dielectric constant greater than that of air and less than that of the rear housing.

In a second aspect of the present disclosure, the millimeter-wave antenna module is provided. The millimeter-wave antenna module includes an antenna array, a feeding module and a buffer layer. The antenna array is disposed on a base and configured to receive or transmit millimeter-wave signals. The base is a rear housing of an electronic device. The feeding module is arranged opposite to the antenna array, and configured to perform coupled feeding to the antenna array. The buffer layer is disposed between the antenna array and the feeding module, and has a dielectric constant greater than that of air and less than that of the base.

The details of one or more embodiments of the present disclosure are set forth in the following drawings and description. Additional features, objects and advantages of the present disclosure become apparent in part from the following descriptions and drawings.

### BRIEF DESCRIPTION OF DRAWINGS

In order to clearly explain technical solutions in embodiments of the present disclosure or in the related art, the drawings to be referred to in descriptions of the embodiments or the related art will be introduced briefly. The drawings in the following descriptions are merely some embodiments of the present disclosure. For those skilled in the art, other drawings may be obtained according to these drawings without inventive work.

FIG. 1 is a perspective view of an electronic device according to an embodiment;

FIG. 2 is a section view of a millimeter-wave antenna module in an electronic device according to an embodiment;

FIG. 3 is a section view of a millimeter-wave antenna module in an electronic device according to another embodiment;

FIG. 4 is a section view of a millimeter-wave antenna module in an electronic device according to still another embodiment;

FIG. 5 is a section view of a millimeter-wave antenna module according to an embodiment;

FIG. 6 is a section view of a first metal layer of a feeding network according to an embodiment; and

FIG. 7 is a block diagram showing a partial structure of a mobile phone related to an electronic device provided in an embodiment of the present disclosure.

### DETAILED DESCRIPTION

In order to make the object, technical solution and advantages of the present disclosure clearer, the present disclosure will be further described in detail below with reference to the accompanying drawings and embodiments. It should be understood that the embodiments described herein are merely used to explain the present disclosure, and may not be construed as a limitation to the present disclosure.

It should be understood that, although terms such as “first” and “second” are used herein for describing various elements, these elements should not be limited by these terms. These terms are only used for distinguishing one element from another element. For example, without departing from the teachings of the present disclosure, a first metal layer could be termed a second metal layer, similarly, a second metal layer could be termed a first metal layer. Both the first metal layer and the second metal layers are metal layers, but are different.

It should be understood that when an element is referred to as “being disposed at” another element, it may be directly disposed at another element or it is also possible that between them there is an intervening element. When an element is referred to as “being connected to” another element, it may be directly connected to another element or it is also possible that between them there is an intervening element.

The present disclosure provides in embodiments a millimeter-wave antenna module for an electronic device including a rear housing 113. In an embodiment, the electronic device may be a mobile phone, a tablet computer, a notebook computer, a palmtop computer, a mobile internet device (MID), a wearable device (such as a smart watch, a smart bracelet, and a pedometer) or other communication modules provided with an antenna.

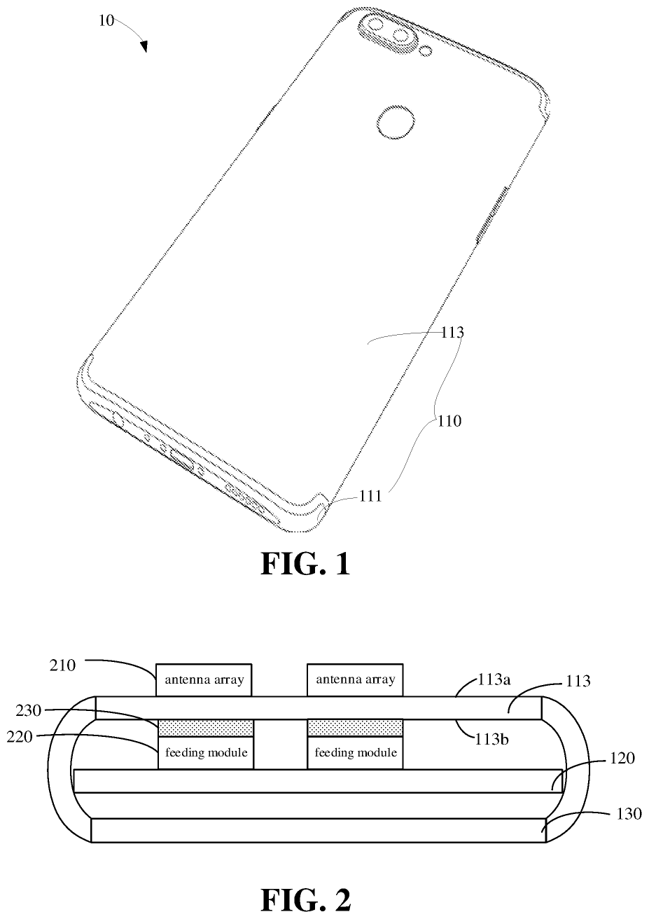

In an embodiment of the present disclosure, as shown in FIG. 1 and FIG. 2, the electronic device 10 includes a housing module 110, a main circuit board 120, a display module 130 and a controller. The display module 130 is fixed to the housing module 110 and forms an external structure of the electronic device together with the housing module 110. The housing module 110 may include a middle housing 111 and the rear housing 113. The middle housing 111 may be a frame structure with through holes, and be accommodated in an accommodating space formed by the display module and the rear housing 113. The rear housing 113 is used to form an external profile of the electronic device. The rear housing 113 may be formed integrally. In a molding process of the rear housing 113, a rear camera hole, a fingerprint identification module, an antenna device mounting hole and other structures may be formed on the rear housing 113. The rear housing 113 may be a non-metallic rear housing 113. For example, the rear housing 113 may be a plastic rear housing 113, a ceramic rear housing 113, or a 3D glass rear housing 113. The main circuit board 120 is fixed inside the housing module, and may be a printed circuit board (PCB) or a flexible circuit board (FPC). An antenna module for transmitting and receiving millimeter-wave signals and a controller configured to control the operation of the electronic device may be integrated on the main circuit board 120. The display module may be used to display pictures or texts, and provide an operating interface.

As shown in FIG. 2, in an embodiment, the millimeter-wave antenna module includes an antenna array 210, a feeding module 220 and a buffer layer 230.

The antenna array 210 is disposed on the rear housing 113 and configured to receive or transmit millimeter-wave signals.

The antenna array 210 for processing the millimeter-wave signals may be implemented as a phased antenna array 210. The antenna array 210 for supporting the millimeter-wave communication may be an antenna array 210 composed of a patch antenna, a dipole antenna, a Yagi antenna, a beam antenna or other suitable antenna elements, which may be selected by those skilled in the art as required, as long as it may receive and transmit the signals.

The antenna array 210 may be composed of a number of patch antenna elements arranged periodically. The number of the antenna arrays 210 is determined according to specific scanning angle and gain requirements. In an embodiment, for two-dimensional scanning, 1×4 antenna arrays 210 are arranged in a rectangle shape. The 1×4 antenna arrays 210 have a relatively high spatial coverage, and may be placed on the left and right sides of the mobile phone in structure, occupying a narrow strip of space in the mobile phone. In a full-space three-dimensional scanning, the antenna array may be arranged rotationally symmetrically, and its shape and position may be changed appropriately.

A working frequency band of the millimeter-wave antenna module, that is, a working frequency band of the antenna array 210, is the millimeter-wave frequency band. The millimeter-wave refers to an electromagnetic wave with a millimeter-scale wavelength and a frequency approximately of 30 GHz to 300 GHz. The millimeter-wave frequency band at least includes a millimeter-wave frequency band of the 5th generation mobile communication system with a frequency of 24250 MHz to 52600 MHz.

The antenna array 210 may be disposed on an inner surface 113a and/or an outer surface 113b of the rear housing 113, and the rear housing 113 is used as a base of the antenna array 210 to prevent the rear housing 113 from blocking the millimeter-wave signals when the antenna array 210 radiates millimeter-wave signals, which improves the radiation efficiency of the millimeter-wave module.

The feeding module 220 is disposed between the rear housing 113 and the main circuit board 120, and arranged opposite to the antenna array 210. The feeding module 220 is connected to the main circuit board 120, and configured to perform coupled feeding to the antenna array 210. The feeding module 220 may be disposed at the main circuit board 120 disposed apart from and faced to the rear housing 113. When the antenna array 210 radiates antenna signals, feeding of the antenna array 210 is realized by coupling the feeding module 220 and the antenna array 210. The feeding module 220 may be laminated by a PCB process or a low temperature co-fired ceramic (LTCC) process. By arranging the feeding module 220 and the antenna array 210 separately, processing difficulty and overall size of the millimeter-wave module are reduced.

The buffer layer 230 is disposed between the antenna array 210 and the feeding module 220, and has a dielectric constant greater than that of air and less than that of the rear housing 113. The dielectric constant of air is about 1, and the dielectric constant of the rear housing 113 is usually about 7. When the millimeter-wave module is operating, energy is emitted from the feeding module 220 to the rear housing 113 via the air, and then the energy is radiated out by the antenna array 210 on the rear housing 113. Providing the buffer layer 230 between the antenna array 210 and the feeding module 220 avoids energy reflections caused by a large difference in the dielectric constant between the air and the rear housing 113 when the millimeter-wave module is operating, thereby avoiding pattern distortion and negative effects on the millimeter-wave radiation performance.

In an embodiment, the dielectric constant of the buffer layer 230 may be a value between the dielectric constant of air and that of the rear housing 113, such as 2, 3, or 4. The specific value may be suitably selected, as long as the dielectric constant of the rear housing 113 may serve as a buffer.

In this embodiment, the millimeter-wave antenna module includes an antenna array 210, disposed on the rear housing 113 and configured to receive or transmit millimeter-wave signals; a feeding module 220, disposed between the rear housing 113 and the main circuit board 120, arranged opposite to the antenna array 210, connected to the main circuit board 120, and configured to perform coupled feeding to the antenna array 210; and a buffer layer 230, disposed between the antenna array 210 and the feeding module 220, and having a dielectric constant greater than that of air and less than that of the rear housing 113. By arranging the antenna array 210 and the feeding module 220 separately, an influence of the rear housing 113 on the antenna array 210 is reduced, and the radiation efficiency of the antenna array 210 is improved. In addition, disposing the buffer layer 230 between the antenna array 210 and the feeding module 220 improves the pattern distortion of the millimeter-wave module and improves the gain of the millimeter-wave module.

In an embodiment, a material of the antenna array 210 may be a conductive material, such as metal materials, alloy materials, conductive silica gel materials, graphite materials, and indium tin oxide (ITO). The material of the antenna array 210 may also be a material with a high dielectric constant, such as glass, plastic and ceramic.

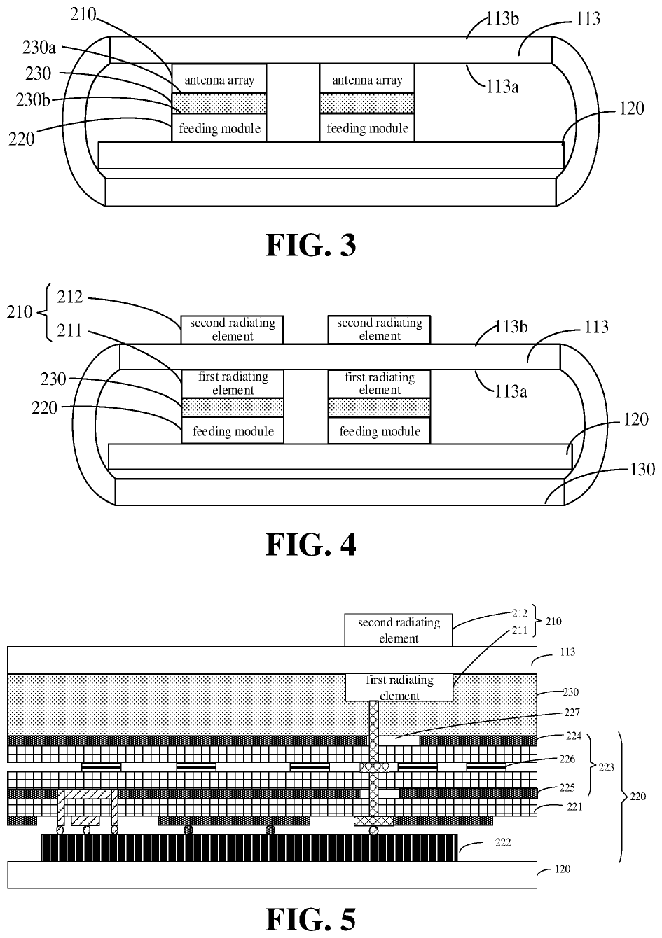

In an embodiment, as shown in FIG. 3, the antenna array 210 is disposed on the inner surface 113a of the rear housing 113, and the buffer layer 230 includes an upper surface 230a and a lower surface 230b opposite to each other. The upper surface 230a is contacted with the antenna array 210, and the lower surface 230b is contacted with the feeding module 220. It should be understood that the upper surface 230a is a surface facing the rear housing 113, and the lower surface 230b is a surface facing the main circuit board 120. The buffer layer 230 is contacted with the antenna array 210 and the feeding module 220, and is configured to support the antenna array 210 and the feeding module 220, thus ensuring that a coupling distance between the antenna array 210 and the feeding module 220 does not change, and improving the stability of the radiation performance of the antenna array 210.

In an embodiment, a ratio of a thickness of the buffer layer 230 to a thickness of the rear housing 113 is in a range of 0.6 to 0.8, which will affect a coupling strength between the feeding module 220 and the antenna array 210, and also affect a standing wave of the antenna array 210, resulting in an impedance mismatch. A ratio of a voltage to a current at an input end of the antenna is called an input impedance of the antenna. For mouth-type antennas, a voltage standing wave ratio on a feeder is usually used to indicate the impedance characteristics of the antenna. Therefore, a reasonable ratio of the thickness of the buffer layer 230 to the thickness of the rear housing 113 may improve the radiation performance of the millimeter-wave module. In this embodiment, the ratio of the thickness of the buffer layer 230 to the thickness of the back shell 113 is in a range of 0.6 to 0.8, which not only ensures the standing wave ratio of the antenna array 210, but also improves the coupling strength between the feeding module 220 and the antenna array 210.

In an embodiment, the thickness of the buffer layer 230 is in a range of 0.4 mm to 1 mm, and the thickness of the rear housing 113 is in a range of 0.5 mm to 1.5 mm. The antenna array 210 is arranged on the rear housing 113, and the rear housing 113 is served as a dielectric base of the antenna array 210. A thickness and a relative dielectric constant of the dielectric base will affect the bandwidth and radiation efficiency of the antenna. In general, the bandwidth and radiation efficiency of the antenna may be improved by increasing the thickness of the dielectric base. However, the increase in the thickness of the dielectric base will increase a weight of the antenna, and radiation of surface waves will be generated as the thickness of the dielectric base is increased. In addition, the thickness of the buffer layer 230 may affect the impedance bandwidth of the antenna array 210. Therefore, in this embodiment, considering the coupling strength between the feeding module 220 and the antenna array 210, the buffer layer 230 has a thickness of 0.4 mm to 1 mm, and the rear housing 113 has a thickness of 0.5 mm to 1.5 mm, which may ensure the coupling strength between the feeding module 220 and the antenna array 210, and improve the bandwidth and radiation efficiency of the antenna.

In an embodiment, the millimeter-wave antenna module further includes an adhesive layer disposed between the buffer layer 230 and the antenna array 210. The adhesive layer may be a glue or other adhesive layers. The buffer layer 230 is adhered to the antenna array 210 and the feeding module 220, respectively, to better support the antenna array 210 and the feeding module 220, thereby ensuring the coupling distance between the antenna array 210 and the feeding module 220.

In an embodiment, a protective layer is adhered on a surface of the antenna array 210, and the protective layer may be a film, or a plastic or other specially processed material layer with a low dielectric constant. Adhering the protective layer on the surface of the antenna array 210 avoids affecting an appearance, and protects the antenna array 210, for example, prevents the antenna array 210 from being scratched.

In an embodiment, as shown in FIG. 4, the rear housing 113 includes the inner surface 113a and the outer surface 113b opposite to each other, and the antenna array 210 includes a first radiating element 211 for radiating a first millimeter-wave band signal and a second radiating element 212 for radiating a second millimeter-wave band signal, the first radiating element 211 and the second radiating element 212 are respectively disposed on the inner surface 113a and the outer surface 113b, and the first millimeter-wave band signal is different from the second millimeter-wave band signal.

In an embodiment, the number of the first radiating elements 211 and the number of the second radiating elements 212 are equal and each greater than 1. A plurality of the first radiating elements 211 and a plurality of the second radiating elements 212 are arranged in an array, and a distance between any two adjacent first radiating elements is the same. For example, the number of the first radiation elements 211 and the number of the second radiation elements 212 may be set as 4, 8, or 16. It should be noted that the plurality of first radiation elements 211 and the plurality of the second radiation elements 212 may be arranged in a linear array, or a two-dimensional array. In the embodiments of the present disclosure, the number and arrangement of the first radiation elements 211 and the second radiation elements 212 may be selected by those skilled in the art as required.

It should be noted that when the first radiating element 211 and the second radiating element 212 radiate antenna signals, a plurality of feeding ways may be used, such as micro-strip line feeding, coaxial line feeding, and slot coupled feeding. In this embodiment, both the first radiating element 211 and the second radiating element 212 may be fed in a slot coupled feeding way to radiate millimeter-wave signals with different frequency bands.

The first millimeter-wave frequency band signal is different from the second millimeter-wave frequency band signal. The millimeter-wave refer to an electromagnetic wave with a millimeter-scale wavelength, and a frequency approximately of 30 GHz to 300 GHz.

3GPP has specified a list of frequency bands supported by 5G NR. The 5G NR spectrum range may reach 100 GHz, and refers to two frequency band ranges: frequency range 1 (FR1), which is a frequency band below 6 GHz, and frequency range 2 (FR2), which is a millimeter-wave frequency band. The FR1 has a range of 450 MHz to 6.0 GHz, and the maximum channel bandwidth is 100 MHz. The FR2 has a range of 24.25 GHz to 52.6 GHz, and the maximum channel bandwidth is 400 MHz. Nearly 11 GHz spectrum used for 5G mobile broadband includes: 3.85 GHz licensed spectrum, for example, including bands of 28 GHz (27.5-28.35 GHz, 2*425 MHz Block), 37 GHz (37.0-38.6 GHz, 8*200 MHz Block), 39 GHz (38.6-40 GHz, 7*200 MHz Block), and 14 GHz unlicensed spectrum (57-71 GHz).

In the embodiment of the present disclosure, the first millimeter-wave frequency band signal may be a 28 GHz frequency band signal, and the second millimeter-wave frequency band signal may be a 39 GHz frequency band signal. It should be noted that the first millimeter-wave frequency band signal and the second millimeter-wave frequency band signal may also be set as other millimeter-wave frequency band signals. That is, the frequency band of the first millimeter-wave band signal is not limited to 28 GHz frequency band, and the frequency band of the second millimeter-wave band signal is not limited to 39 GHz frequency band.

In an embodiment, as shown in FIG. 5, the feeding module 220 includes a substrate 221, a package chip 222, a control circuit and a feeding network 223. The package chip 222 is disposed on a surface of the substrate 221 facing the main circuit board 120. The feeding network 223 is disposed in the substrate 221, and arranged opposite to the antenna array 210, connected to the package chip 222 via the control circuit and configured to perform the coupled feeding on the antenna array 210.

The feeding network 223 is a strip-like line, which may better control the impedance, and provide a good shielding effect to effectively reduce the loss of electromagnetic energy, and thus improve the efficiency of the antenna array 210. The feeding network 223 includes a first metal layer 224 near to the antenna array 210, a second metal layer 225 disposed apart from and opposite to the first metal layer 224, and a strip-like line layer 226 disposed between the first metal layer 224 and the second metal layer 225 and apart from the first metal layer 224 and the second metal layer 225. The first metal layer 224 has a slot 227 at a position corresponding to the array antenna, and the feeding network 223 is configured to perform the coupled feeding to the antenna array 210 through the slot 227. The number of slots 227 is matched with the number of antenna arrays 210, and each antenna array 210 is coupled with and fed by the feeding network 223 through the slot 227. Specifically, the electromagnetic energy is coupled to the antenna array 210 through the slot 227.

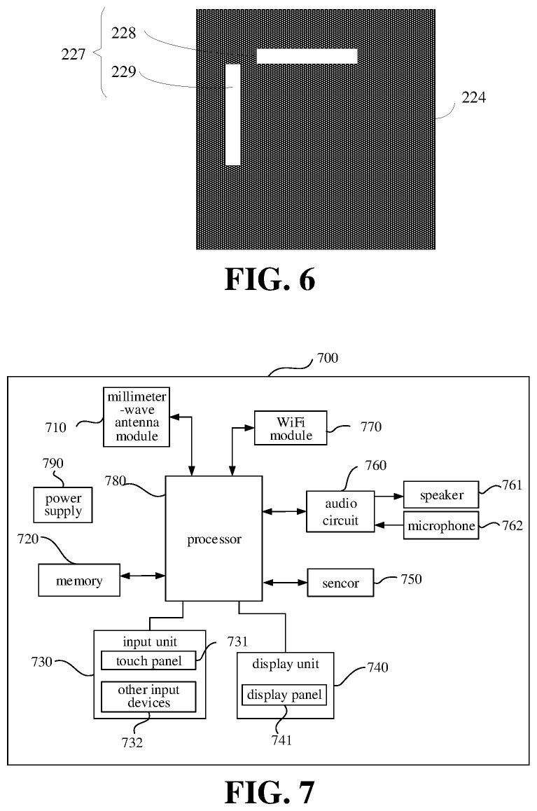

In an embodiment, as shown in FIG. 6, the slot 227 includes a first slot 228 and a second slot 229 arranged orthogonally. The feeding network 223 is configured to perform the coupled feeding to the first radiating element 211 through the first slot 228, and perform the coupled feeding to the second radiating element 212 through the second slot 229.

In this embodiment, when the millimeter-wave module is operating and the system transmits vertical polarization signals and horizontal polarization signals, a vertical polarization port of the package chip 222 transmits the vertical polarization signals to a feeding point through the first slot 228 of the feeding network 223, and the vertically polarized signals are fed to the first radiating element 211 by the feeding point. Energy coupled to the first radiating element 211 will excite a resonance of a current to radiate the millimeter-wave signal of the first millimeter-wave band to space. A horizontal polarization port of the package chip 222 transmits the horizontal polarization signals to a feeding point through the second slot 229 of the feeding network 223, and the horizontal polarized signals are fed to the second radiating element 212 by the feeding point. Energy coupled to the second radiating element 212 will excite a resonance of a current to radiate the millimeter-wave signal of the second millimeter-wave band to space.

The first slot 228 and the second slot 229 are arranged orthogonally, which may be used for receiving and sending two signals having polarization modes perpendicular to each other simultaneously to realize a dual polarization without mutual interference and improve isolation.

In an embodiment, a cross-sectional shape of the slot 227 is rectangular, “H”-shaped, or “T”-shaped. In other embodiments, the cross-sectional shape of the slot 227 is square, circular or triangular. Furthermore, an orthographic projection of the slot 227 toward the antenna array 210 falls within a range of the antenna array 210.

The present disclosure also provides in embodiments an electronic device including the above-mentioned millimeter-wave antenna module in any embodiment.

In an embodiment, the above-mentioned millimeter-wave antenna module may be disposed at the frame of the electronic device. By providing an antenna window at the frame or using a non-metal battery cover plate, the millimeter-waves may be received and transmitted.

The electronic device has a top and a bottom, and the top and the bottom are relatively arranged along a length direction of the electronic device. It should be noted that the bottom of the electronic device is usually near to a part held by the user. In designing the millimeter-wave antenna module, the millimeter-wave antenna module may be made closer to the top than the bottom to reduce the influence on the antenna when holding the electronic device. Optionally, the millimeter-wave antenna module may also be arranged on opposite sides in a width direction of the electronic device, and each millimeter-wave antenna module is arranged in the length direction of the mobile electronic device. In other words, the millimeter-wave antenna device may be arranged at a long side of the electronic device.

The electronic device with the above-mentioned millimeter-wave antenna module of any of the embodiments may improve the pattern distortion of the millimeter-wave module and increase the gain of the millimeter-wave module.

The electronic device may include a mobile phone, a tablet computer, a notebook computer, a palmtop computer, a mobile internet device (MID), a wearable device (such as a smart watch, a smart bracelet, and a pedometer) or other communication modules provided with an antenna.

The embodiments of the present disclosure also provides an electronic device. As shown in FIG. 7, for ease of description, only the parts related to the embodiments of the present disclosure are shown. Specific technical details that are not disclosed here may refer to the contents of methods of the embodiments of the present disclosure. The electronic device may be any terminal device including a mobile phone, a tablet computer, a personal digital assistant (PDA), a point of sales (POS), an on-board computer, a wearable device, etc. In embodiments of the present disclosure, the electronic device is a mobile phone.

FIG. 7 is a block diagram showing a partial structure of a mobile phone related to an electronic device provided by an embodiment of the present disclosure. As shown in FIG. 7, the mobile phone includes a millimeter-wave antenna module 710, a memory 720, an input unit 730, a display unit 740, a sensor 750, an audio circuit 760, a wireless fidelity (WiFi) module 770, a processor 780, a power supply 790 and other components. It should be understood by those skilled in related art that the structure of the mobile phone shown in FIG. 7 is not construed to limit the mobile phone, and may include more or less components than the components shown, or may be combined with some other components, or may have different component arrangements.

The array antenna 710 may be configured to receive and transmit signals during receiving and transmitting information or during a call. After receiving down-link information of a base station, the array antenna 710 may transmit the information to the processor 780. The array antenna 710 may transmit uplink data to the base station. Generally, the millimeter-wave antenna module includes, but is not limited to, an antenna, at least one amplifier, a transceiver, a coupler, a low noise amplifier (LNA), and a duplexer. In addition, the millimeter-wave antenna module 710 may also communicate with the network and other devices through wireless communication. The above-mentioned wireless communication may use any communication standard or protocol, including, but not limited to, a global system of mobile communication (GSM), a general packet radio service (GPRS), a code division multiple access (CDMA), a wideband code division multiple access (WCDMA), a long term evolution (LTE), an E-mail, and a short messaging service (SMS).

The memory 720 may be configured to store software programs and modules that, when executed by the processor 780, cause the processor to perform various function applications and data processing of the mobile phone. The memory 720 may include a program memory area and a data memory area. The program memory area may store an operating system, an application program required for at least one function (such as an application program for sound playing function, and an application program for image displaying function). The data memory area may store data (such as audio data, and address book) that is established during the use of the mobile phone. In addition, the memory 720 may include a high-speed random access memory and also a non-volatile memory, such as at least one disk memory member, a flash memory, or other volatile solid memory members.

The input unit 730 may be configured to receive input digital or character information, and generate a signal input of a key that is related to user setting and function control of the mobile phone 700. Specially, the input unit 730 may include a touch panel 731 and other input devices 732. The touch panel 731 also known as a touch screen, may collect user's touch operations on or near it (such as user's operations on or near the touch panel 731 with any suitable object or accessory such as a finger, and a touch pen), and drive a corresponding connection device according to a preset program. In an embodiment, the touch panel 731 may include two parts: a touch measuring device and a touch controller. The touch measuring device measures a touch orientation of the user, measures a signal generated by the touch operation, and transmits the signal to the touch controller. The touch controller receives touch information from the touch measuring device, converts it into a contact coordinate, then sends it to the processor 780, and receives and executes a command sent from the processor 780. In addition, various kinds of touch panels 731 may be realized, such as a resistance touch panel, a capacitance touch panel, an infrared touch panel and a surface-acoustic-wave touch panel. Besides the touch panel 731, the input unit 730 may further include other input devices 732. In an embodiment, the other input devices 732 may include, but are not limited to, one or more of a physical keyboard, and a function key (such as a volume control key, and a switch key).

The display unit 740 may be configured to display information that is input by the user or provided to the user and various menus of the mobile phone. The display unit 740 may include a display panel 741. In an embodiment, the display panel 741 may be configured in a form of a liquid crystal display (LCD), and an organic light-emitting diode (OLED). In an embodiment, the touch panel 731 may cover the display panel 741. When the touch panel 731 measures a touch operation on it or near it, the touch operation is transmitted to the processor 780 to determine a type of the touch operation. Then, the processor 780 provides a corresponding visual output on the display panel 741 according to the type of touch operation. Although in FIG. 7, the touch panel 731 and the display panel 741 serve as two independent components to realize the input and output functions of the mobile phone, the touch panel 731 and the display panel 741 may be integrated to realize the input and output functions of the mobile phone in some embodiments.

The mobile phone 700 may further include at least one sensor 750, such as an optical sensor, a motion sensor, and other sensors. In an embodiment, the light sensor may include an ambient light sensor and a proximity sensor. The ambient light sensor may adjust a brightness of the display panel 741 according to light and shade of an ambient light, and the proximity sensor may turn off the display panel 741 and/or the backlight when the mobile phone moves to an ear. The motion sensor may include an acceleration sensor, which may be configured to measure an acceleration in any direction. When the motion sensor stays still, it may measure a magnitude and a direction of gravity, which may be used to applications of identifying a posture of a mobile phone (such as a horizontal and vertical screen switching), and functions related to vibration identification (such as a pedometer, a percussion). In addition, the mobile phone may be provided with a gyroscope, a barometer, a hygrometer, a thermometer, an infrared sensor and other sensors.

An audio circuit 760, a speaker 761 and a microphone 762 may provide an audio interface between the user and the mobile phone. The audio circuit 760 may transmit an electrical signal which is converted from received audio data, to the speaker 761, and the speaker 761 converts the electrical signal to a sound signal to be output. On the other hand, the microphone 762 converts a collected audio signal into an electrical signal, the audio circuit 760 receives the electrical signal and convers the electrical signal into audio data, and the audio data is output to the processor 780. After the audio data is processed by the processor 780, the processed audio data is sent to another mobile phone by the array antenna 710, or output to the memory 720 for subsequent processing.

WiFi belongs to a short-distance wireless transmission technology. The user may send and receive emails, browse web pages, and access streaming media through the mobile phone with the help of the WiFi module 770, and the WiFi module 770 provides the user with wireless broadband Internet access. Although FIG. 7 shows the WiFi module 770, it should be noted that it is not a necessary component of the mobile phone 700 and may be omitted as required.

The processor 780 is a control center of the mobile phone, which may be connected to all parts of the mobile phone via various interfaces and lines, and perform various functions of the mobile phone and process data by running or executing software programs and/or modules stored in the memory 720 and invoking data stored in the memory 720, so as to monitor the overall mobile phone. In an embodiment, the processor 780 may include one or more processing units. In an embodiment, the processor 780 may integrate an application processor and a modulating-demodulating processor. The application processor may process an operating system, a user interface, an application program, and so on. The modulating-demodulating processor may process a wireless communication. It should be understood that the above modulating-demodulating processor may not be integrated into the processor 780.

The mobile phone 700 further includes a power supply 790 (such as a battery) for supplying power to each component. In some embodiments, the power supply may be logically connected to the processor 780 through a power management system, so as to realize functions of charging, discharging, and power consumption management through the power management system.

In an embodiment, the mobile phone 700 may further include a camera, a Bluetooth module, and so on.

Any reference to a memory, a storage, a database or other media used in the present disclosure may include a non-volatile and/or volatile memory. A suitable non-volatile memory may include a read-only memory (ROM), a programmable ROM (PROM), an electrically programmable ROM (EPROM), an electrically erasable programmable ROM (EEPROM), or a flash memory. The volatile memory may include a random access memory (RAM), which is used as an external cache memory. The RAM may be obtained in many forms, such as a static random access memory (SRAM), a dynamic random access memory (DRAM), a synchronous dynamic random access memory (SDRAM), a double data rate synchronous dynamic random access memory (DDRSDRAM), an enhanced synchronous dynamic random access memory (ESDRAM), a Synchlink dynamic random access memory (SLDRAM), a Rambus direct dynamic random access memory (RDRAM), a direct Rambus dynamic random access memory (DRDRAM), and a Rambus dynamic random access memory (RDRAM).

The above embodiments only represent several embodiments of the present disclosure, and the descriptions thereof are specific and detailed, which shall not be construed as a limitation of the protection scope of the present disclosure. It should be noted that for those skilled in the art, several changes and modifications may be made without departing from the principle of the present disclosure, which belong to the protection scope of the present disclosure. Therefore, the protection scope of the patent disclosure shall be in accordance with the appended claims.

What is claimed is:

1. An electronic device, comprising:
a rear housing;
a main circuit board disposed apart from and faced to the rear housing; and
a millimeter-wave antenna module, wherein the millimeter-wave antenna module comprises:
an antenna array, disposed on the rear housing and configured to receive or transmit millimeter-wave signals;
a feeding module, disposed between the rear housing and the main circuit board, and arranged opposite to the antenna array, wherein the feeding module is connected to the main circuit board, and configured to perform coupled feeding to the antenna array; and
a buffer layer, disposed between the antenna array and the feeding module, and having a dielectric constant greater than that of air and less than that of the rear housing.

2. The electronic device according to claim 1, wherein the feeding module is disposed on the main circuit board disposed apart from and faced to the rear housing.

3. The electronic device according to claim 1, wherein the antenna array is arranged on an inner surface and/or an outer surface of the rear housing.

4. The electronic device according to claim 1, wherein the buffer layer has an upper surface and a lower surface disposed opposite to the upper surface, the upper surface is contacted with the antenna array and the lower surface is contacted with the feeding module.

5. The electronic device according to claim 1, wherein the feeding module comprises:
a substrate;
a package chip, disposed on a surface of the substrate facing the main circuit board;
a control circuit; and
a feeding network, disposed in the substrate, and arranged opposite to the antenna array, connected to the package chip via the control circuit and configured to perform the coupled feeding to the antenna array.

6. The electronic device according to claim 5, wherein the feeding network is a strip-like line.

7. The electronic device according to claim 1, wherein a ratio of a thickness of the buffer layer to a thickness of the rear housing is in a range of 0.6 to 0.8.

8. The electronic device according to claim 1, wherein the buffer layer has a thickness of 0.4 mm to 1 mm, and the rear housing has a thickness of 0.5 mm to 1.5 mm.

9. The electronic device according to claim 1, further comprising an adhesive layer disposed between the buffer layer and the antenna array.

10. The electronic device according to claim 1, wherein a protective layer is adhered on a surface of the antenna array and is a film or a plastic layer with a low dielectric constant.

11. The electronic device according to claim 5, wherein the feeding network is a strip-like line, comprising:
a first metal layer, near to the antenna array,
a second metal layer, disposed apart from and opposite to the first metal layer, and
a strip-like line layer, disposed between the first metal layer and the second metal layer, and apart from the first metal layer and the second metal layer;
wherein the first metal layer has a slot at a position corresponding to the array antenna, and the feeding network is configured to perform the coupled feeding to the antenna array through the slot.

12. The electronic device according to claim 11, wherein the rear housing has an inner surface and an outer surface opposite to each other, and the antenna array comprises a first radiating element for radiating a first millimeter-wave band signal and a second radiating element for radiating a second millimeter-wave band signal, the first radiating element and the second radiating element are respectively disposed on the inner surface and the outer surface, and the first millimeter-wave band signal is different from the second millimeter-wave band signal.

13. The electronic device according to claim 12, wherein the number of the first radiating elements and the number of the second radiating elements are equal and each greater than 1.

14. The electronic device according to claim 13, wherein a plurality of the first radiating elements and a plurality of the second radiating elements are arranged in an array, and a distance between any two adjacent first radiating elements is the same.

15. The electronic device according to claim 12, wherein the slot comprises a first slot and a second slot arranged orthogonally, wherein the feeding network is configured to perform the coupled feeding to the first radiating element through the first slot, and perform the coupled feeding to the second radiating element through the second slot.

16. The electronic device according to claim 11, wherein a cross-sectional shape of the slot is rectangular, “H”-shaped, “T”-shaped, circular or triangular.

17. The electronic device according to claim 11, wherein an orthographic projection of the slot toward the antenna array falls within a range of the antenna array.

18. The electronic device according to claim 1, wherein the antenna array comprises a plurality of patch antenna elements arranged periodically.

19. The electronic device according to claim 1, wherein the millimeter-wave antenna module is arranged at a long side of the electronic device.

20. A millimeter-wave antenna module, comprising:
an antenna array, disposed on a base and configured to receive or transmit millimeter-wave signals, wherein the base is a rear housing of an electronic device;
a feeding module, arranged opposite to the antenna array, and configured to perform coupled feeding to the antenna array; and
a buffer layer, disposed between the antenna array and the feeding module, and having a dielectric constant greater than that of air and less than that of the base.
